(19) United States
(12) Patent Application Publication
(10) Pub. No.: US 2005/0060529 A1
(43) Pub. Date: Mar. 17, 2005

(54) Remote reboot method and system for network-linked computer platform

(76) Inventor: Chih-Wei Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/655,168

(22) Filed: Sep. 4, 2003

(51) Int. Cl. G06F 15/177; G06F 9/445

(52) U.S. Cl. 713/2

(57) ABSTRACT

A remote reboot method and system for network-linked computer platform is proposed, which is designed for use with a network system linked to at least one computer platform that is equipped with a special type of network chip and a special type of I/O control chip, for providing a remote reboot function to the computer platform. The proposed remote reboot method and system can be implemented simply by configuring existing hardware/software facilities on the computer platform with the additional installation of only a new functional module called SMI signal judgment module in the computer platform's BIOS, it allows a more cost-effective way of providing a remote reboot function for crash recovery of the network-linked computer platform.

### BACKGROUND OF THE INVENTION

1. Field of the Invention

This invention relates to computer network technology, and more particularly, to a remote reboot method and system for network-linked computer platform, which is designed for use with a network system to allow network management personnel to remotely initiate a reboot procedure to a network-linked computer platform, such as a server or a client workstation, in the event of a system crash to the computer platform, for crash recovery of the computer platform back to normal operation.

2. Description of Related Art

A network-linked computer platform, such as a network server, is typically equipped with a remote wakeup function and a remote reboot function. The remote wakeup function allows network management personnel to remotely switch on the power supply on the network server and thereby put the network server into active operation to provide data services to clients or to allow the network management personnel to perform remote system management tasks on the server. In the event of a system crash to the server, the remote reboot function then allows the network management personnel to remotely initiate a reboot procedure to the server for crash recovery of the computer platform back to normal operation.

FIG. 1 is a schematic diagram showing a conventional remote wakeup architecture for a network-linked computer platform 10. As shown, this remote wakeup architecture allows the network management personnel to remotely initiate a wakeup procedure via a network system 101 to the computer platform 10 (which can be either a network server or a client workstation). In this conventional architecture, the computer platform 10 should be installed with an additional and expensive Wake-on-LAN module 20 which is linked to the power module 13 of the main system unit 14 of the computer platform 10. When the network management personnel activates the workstation 30 to issue a wakeup enable signal, it will be transmitted via the network system 101 to the Wake-on-LAN system 20 which then responsively issues a switch-on signal to the power module 13, causing the power module 13 to be switched on and the computer platform 10 to undergo a boot procedure.

One drawback to the foregoing remote wakeup architecture, however, is that the Wake-on-LAN module 20 is only capable of providing a remote wakeup procedure to the computer platform 10, i.e., only when the computer platform 10 is in power-off state, and is incapable of providing a remote reboot function to the computer platform 10 in the event of a system crash to the computer platform 10. For this sake, in the event of system crash to the computer platform 10, the network management personnel will have to walk to the site where the computer platform 10 is installed and manually initiate a reboot procedure to the computer platform 10, which is quite laborious and inconvenient to network management.

### SUMMARY OF THE INVENTION

It is an objective of this invention to provide a remote reboot method and system for network-linked computer platform which allows the network management personnel to remotely reboot a network-linked computer platform in the event of a system crash to the computer platform without having to install additional hardware/software facilities to the computer platform so as to make network management more efficient and cost-effective.

The remote reboot method and system for network-linked computer platform according to the invention is designed for use with a network system linked to at least one computer platform that is equipped with a special type of network chip (such as Ethernet-compliant network chip) and a special type of I/O control chip (such as a Super I/O chip), for providing a remote reboot to the computer platform over the network system in the event of a system crash to the computer platform.

The remote reboot method and system for network-linked computer platform according to the invention is characterized in that in the event of a system crash to the computer platform, the network management personnel needs just to activate the issuing of a PME packet from his/her workstation, and the issued PME packet will be transferred via the network system to the network chip on the computer platform, which causes the network chip to issue a PME signal to the I/O control chip in response to the PME packet. The I/O control chip then generates an SMI signal in response to the PME signal. If the SMI signal generated by the SMI signal generating module is activated by PME signal, a boot enable signal is issued to the computer platform, causing the computer platform to undergo a reboot procedure.

Compared to prior art, since the invention can be implemented simply by configuring existing hardware/software facilities on the computer platform with the additional installation of only a new functional module (i.e., the SMI signal judgment module) in the computer platform's BIOS, it allows a more cost-effective way of providing a remote reboot function for crash recovery of the network-linked computer platform.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic diagram showing a conventional remote wakeup architecture for a network-linked computer platform;

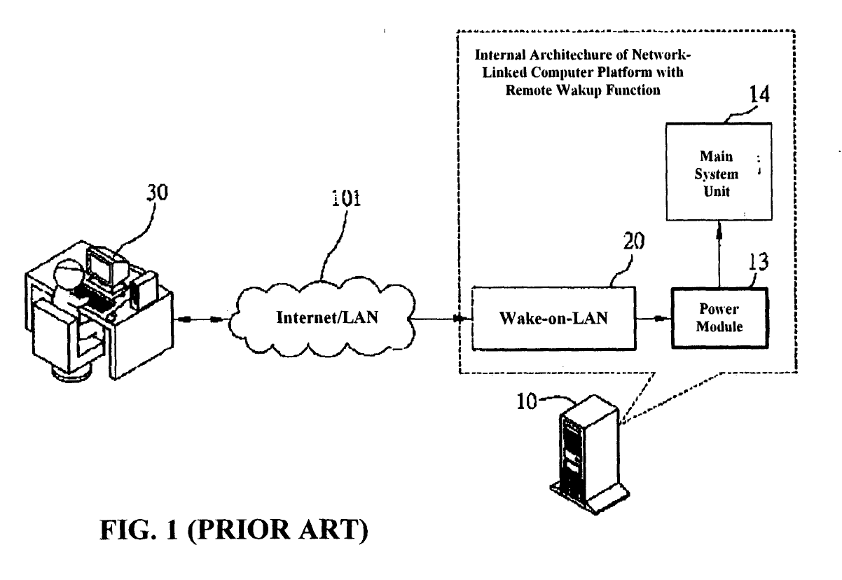

FIG. 2 is a schematic diagram showing the basic internal architecture of a computer platform that can be used with the remote reboot method and system of the invention; and

FIG. 3 is a schematic diagram showing an object-oriented component model of the remote reboot system for network-linked computer platform according to the invention.

### DETAILED DESCRIPTION OF PREFERRED EMBODIMENTS

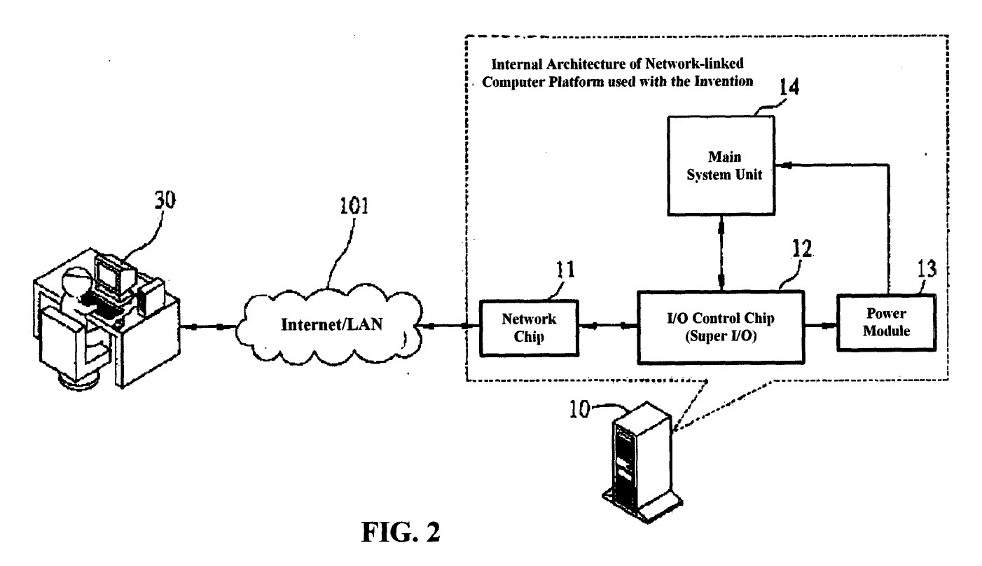

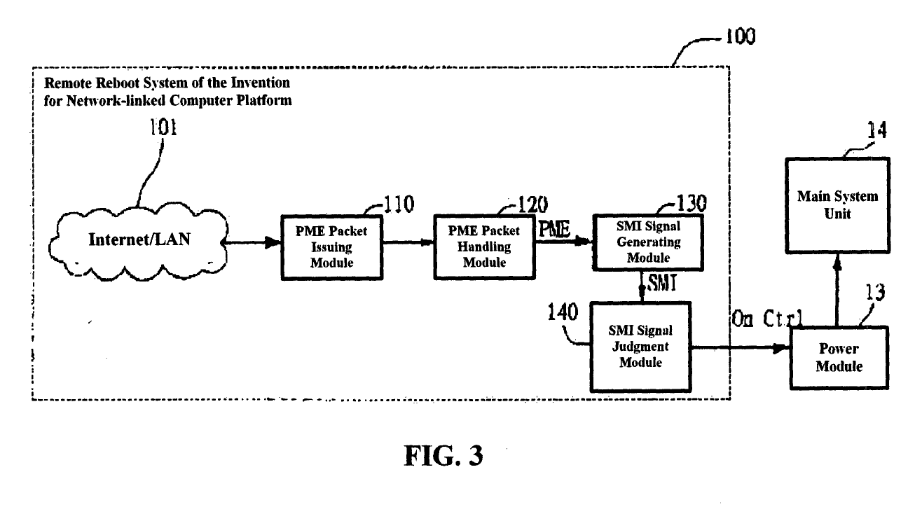

The remote reboot method and system for network-linked computer platform according to the invention is disclosed in full details by way of preferred embodiments in the following with reference to FIG. 2 and FIG. 3.

FIG. 2 is a schematic diagram showing the basic internal architecture of a computer platform 10 (which can be either a server or a client workstation) on which the invention is realizable. As shown, the computer platform 10 should be linked to a network system 101 such as Internet or a LAN (Local Area Network) system, and whose internal system configuration should include a special type of network chip 11, such as an Ethernet-compliant network chip, and a special type of I/O control chip 12, such as a Super I/O chip.

On the network-linked computer platform 10, the invention allows network management personnel to remotely initiate a wakeup procedure or a reboot procedure to the computer platform 10 via the network system 101 in the event of a system crash to the computer platform 10, i.e., when the computer platform 10 is in power-off state, the network management personnel can power on and boot the computer platform 10 remotely from his/her workstation 30; and in the event of a system crash to the computer platform 10, the network management personnel can remotely reboot the computer platform 10 from his/her workstation 30 for crash recovery of the computer platform 10 back to normal operation.

As shown in FIG. 3, the object-oriented component model of the remote reboot system of the invention 100 comprises: (a) a PME (Power Management Event) packet issuing module 110; (b) a PME packet handling module 120; (c) an SMI (System Management Interrupt) signal generating module 130; and (d) an SMI signal judgment module 140.

The PME packet issuing module 110 is installed on the network management personnel's workstation 30, and which is capable of allowing the network management personnel to activate the issuing of a PME (Power Management Event) packet via the network system 101 to the network chip 11 on the computer platform 10. Since PME (Power Management Event) is an existing and well-known standard of computer hardware architecture, detailed description thereof will not be given here in this specification.

The PME packet handling module 120 is an integrated built-in functional module in the network chip 11 on the computer platform 10, which is used to receive the PME packet from the PME packet issuing module 110 on the workstation 30, and which is capable of responsively issuing a PME signal to the I/O control chip 12.

The SMI (System Management Interrupt) signal generating module 130 is an integrated built-in functional module in the I/O control chip 12 on the computer platform 10, and which is capable of generating an SMI (System Management Interrupt) signal when the GPIO (General Purpose Input/Output) ports of I/O control chip 12 receives the PME signal from the PME packet handling module 120. Since SMI (System Management Interrupt) is an existing and well-known standard of computer hardware architecture, detailed description thereof will not be given here in this specification.

The SMI signal judgment module 140 is, for example, an add-in functional module to the BIOS of the computer platform 10, which is capable of judging whether the SMI signal generated by the SMI signal generating module 130 is activated by PME signal; and if YES, the SMI signal judgment module 140 promptly issues a boot enable signal OnCtrl to the power module 13 of the computer platform 10 to cause the computer platform 10.

In the presence of the boot enable signal OnCtrl, if the computer platform 10 is in power-off state, it will cause the computer platform 10 to undergo a power-on and boot procedure; whereas if the computer platform 10 is in the state of a system crash, it will cause the main control unit 14 (i.e., the CPU and OS) of the computer platform 10 to undergo a reboot procedure so as to resume the computer platform 10 back to normal operation.

In actual application, the remote reboot system of the invention 100 allows the user (i.e., any member of network management personnel) to initiate a remote wakeup procedure or a remote reboot procedure through the user's workstation 30 and via the network system 101 to the computer platform 10. Both of these two procedures require the user to perform a single action: activate the PME packet issuing module 110 installed on the workstation 30 to issue a PME packet.

The PME packet issued by the PME packet issuing module 110 is then transferred via the network system 101 to the network chip 11 on the computer platform 10. In response, the PME packet handling module 120 promptly issues a PME signal to the I/O control chip 12, causing the SMI signal generating module 130 in the I/O control chip 12 to generate an SMI signal. This causes the SMI signal judgment module 140 in BIOS to be activated to judge whether the SMI signal generated by the SMI signal generating module 130 is activated by PME signal; and if YES, the SMI signal judgment module 140 promptly issues a boot enable signal OnCtrl to the power module 13 of the computer platform 10. If the computer platform 10 is currently in power-off state, the boot enable signal OnCtrl will cause the computer platform 10 to undergo a power-on and boot procedure; whereas if the computer platform 10 is currently in the state of a system crash, it will cause the main control unit 14 of the computer platform 10 to undergo a reboot procedure for crash recovery of the computer platform 10 back to normal operation.

In conclusion, the invention provides a remote reboot method and system for network-linked computer platform which is designed for use on a network-linked computer platform that is equipped with a special type of network chip and a special type of I/O control chip, for providing a remote wakeup and reboot capability to the computer platform. Compared to prior art, since the invention can be implemented simply by configuring existing hardware/software facilities on the computer platform with the additional installation of only a new functional module (i.e., the SMI signal judgment module) in the computer platform's BIOS, it allows a more cost-effective way of providing a remote reboot function for crash recovery of the network-linked computer platform. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A remote reboot method for use on a network system linked to at least one computer platform that is equipped with a special type of network chip and a special type of I/O control chip, for providing a remote reboot function to the computer platform;
the remote reboot method comprising:
issuing a PME packet via the network system to the network chip on the computer platform;
in response to the PME packet, activating the network chip to issue a PME signal to the I/O control chip;
in response to the PME signal, activating the I/O control chip to generate an SMI signal; and
judging whether the SMI signal generated by the SMI signal generating module is activated by PME signal; if yes, issuing a boot enable signal to the computer platform to cause the computer platform to undergo a reboot procedure.

2. The remote reboot method of claim 1, wherein the network chip is an Ethernet-compliant network chip.

3. The remote reboot method of claim 1, wherein the I/O control chip is a Super I/O chip.

4. The remote reboot method of claim 1, wherein the network system is Internet.

5. The remote reboot method of claim 1, wherein the network system is a LAN system.

6. A remote reboot system for use with a network system linked to at least one computer platform that is equipped with a special type of network chip and a special type of I/O control chip, for providing a remote reboot function to the computer platform;
the remote reboot system comprising:
a PME packet issuing module, which is capable of issuing a PME packet via the network system to the network chip on the computer platform;
a PME packet handling module, which is installed in the network chip on the computer platform for receiving the PME packet from the PME packet issuing module, and which is capable of issuing a PME signal in response to the PME packet;
an SMI signal generating module, which is installed in the I/O control chip on the computer platform, and which is capable of generating an SMI signal in response to the PME signal from the PME packet handling module; and
an SMI signal judgment module, which is capable of judging whether the SMI signal generated by the SMI signal generating module is activated by PME signal; if yes, the SMI signal judgment module issuing a boot enable signal to cause the computer platform to undergo a reboot procedure.

7. The remote reboot system of claim 6, wherein the network chip is an Ethernet-compliant network chip.

8. The remote reboot system of claim 6, wherein the I/O control chip is a Super I/O chip.

9. The remote reboot system of claim 6, wherein the network system is Internet.

10. The remote reboot system of claim 6, wherein the network system is a LAN system.
